(19) United States
(12) Patent Application Publication
(10) Pub. No.: US 2020/0078718 A1
(43) Pub. Date: Mar. 12, 2020

(54) AIR FILTER MEDIA MANUFACTURING PROCESS AND TOOLING FOR SAME

(71) Applicant: Parker-Hannifin Corporation, Cleveland, OH (US)

(72) Inventors: Charles R. Wick, Pleasanton, NE (US); Farrell F. Calcaterra, Kearney, NE (US); Simon D. Ritchie, Kearney, NE (US); Jason Mei, East Meadow, NY (US)

(21) Appl. No.: 16/563,380

(22) Filed: Sep. 6, 2019

Related U.S. Application Data
(60) Provisional application No. 62/728,108, filed on Sep. 7, 2018.

(51) Int. Cl. B01D 46/00; B01D 46/52

(52) U.S. Cl. CPC B01D 46/0001; B01D 46/523

(57) ABSTRACT

Methods of processing filter media sheets to provide geometries therein are provided. Tooling for use in the methods are also provided. The tooling has a low static coefficient of friction relative to the filter media sheet and a sufficient wetting contact angle to prevent sticking of the filter media sheet to the tooling so as to avoid damaging the filter media sheet and to provide consistently formed geometries in the filter media sheet.

### CROSS-REFERENCE TO RELATED PATENT APPLICATIONS

This patent application claims the benefit of U.S. Provisional Patent Application No. 62/728,108, filed Sep. 7, 2018, the entire teachings and disclosure of which are incorporated herein by reference thereto.

### FIELD OF THE INVENTION

This invention generally relates to methods of forming pleated filter media and particularly multi-layer pleated filter media.

### BACKGROUND OF THE INVENTION

A variety of filter packs are known in the prior art, for example U.S. Pat. No. 6,780,217 to Palmer; U.S. Pat. No. 7,122,068 to Tate et al; U.S. Pub. No. 2006/0151383 to Choi; U.S. Pat. No. 4,268,290 to Barrington. Each of the aforementioned patents and publications generally relate to pleated filter media elements.

There are also other filter media packs such as fluted media packs described and shown for example in U.S. Pub. No. 2014/0260139 entitled Rectangular Stacked Fluted Filter Cartridge to Merritt; and U.S. Pat. No. 7,318,851 entitled Filter Element to Brown et al.

One process for processing the filter media to be used in such filter media packs employed by the above examples requires the use of rolls that have projecting features that rotate around a central axis in order to form geometries such as embossments, corrugations or other features into the filter media that forms the filter media pack such as shown for example in Choi, U.S. Pub. No. 2006/0151383 entitled Pleated Corrugated Media and Method of Making. The advantage of the roll forming process is the ability for continuous processing in that the rolls rotate and operate continuously on a continuous filter media sheet that is unwound from a filter media roll in a typical process.

Other processes for processing the filter media and to form geometries in the filter media press the filter media pressed between sets of press plates to form the geometry that may include embossments, corrugations or other features into the filter media as well as to cause the filter media to be folded to form the various pleat panels such as shown in PCT Publ. No. WO 2018/152090 filed Feb. 13, 2018. Some systems may use press plates to form the geometries and use rotating rolls to cause adjacent pleat panels to be folded relative to one another such as shown in PCT Publ. No. WO 2017/031168 filed Aug. 17, 2016. These processes may include heating the press plates and/or filter media.

Unfortunately, if the filter media includes adhesives or bi-component materials, the filter media may stick to the tooling used to form the desired geometry (e.g. embossments or other features) as well as to the tooling for folding the filter media between adjacent pleat panels. The sticking of the filter media to the tooling can damage the filter media or degrade the quality of the formed geometry. This is particularly true when heating is employed to form and/or set the geometries.

Various aspects of the present invention are directed towards improvements in the methods of processing the filter media for making such embossments or features and packs including the filter media as will be understood from the disclosure below.

### BRIEF SUMMARY OF THE INVENTION

Methods are provided for processing filter media sheets and particularly filter media sheets that tend to stick to tooling used to form geometries in the filter media sheet.

A first process for forming a first geometry in a filter media sheet includes providing a press tooling, pressing the filter media sheet and removing the filter media sheet from the press tooling. More particularly, the press tooling includes a forming surface for forming the first geometry. The forming surface of the press tooling has a static coefficient of friction relative to the filter media sheet of between about 0.9 and 0.02 and a wetting contact angle ranging from about 90 to about 180. The step of pressing includes pressing the filter media sheet with the forming surface of the first press tooling to form the first geometry in the filter media sheet. Thereafter, the formed filter media sheet is removed from the first press tooling.

By providing a forming surface with a static coefficient of friction and a high enough contact angle, the filter media sheet will not undesirably stick to the press tooling causing damage to the filter media sheet.

In one implementation, the static coefficient of friction of the forming surface of the first press tooling relative to the filter media sheet is between about 0.04 to 0.2.

In one implementation, the wetting contact angle is between about 90 to 140.

In one implementation, the method further includes folding the filter media sheet to form a plurality of pleat panels from the filter media sheet.

In one implementation, pleat panels of a first set of the plurality of pleat panels include the first geometry formed by the first press tooling. Pleat panels of a second set of the plurality of pleat panels have a second geometry different than the first geometry. Each adjacent pair of pleat panels includes a pleat panel of the first set of the plurality of pleat panels and a pleat panel of the second set of the plurality of pleat panels. The pleat panel of the first set of the plurality of pleat panels of the adjacent pair being separated from the pleat panel of the second set of the plurality of pleat panels by a fold.

The first geometry formed in the first set of pleat panels may be used as a pleat spacer separating a first pleat panel from an adjacent second pleat panel.

In one implementation, the method includes applying a release coating to the forming surface of the first press tooling. The release coating providing a coefficient of friction relative to the filter media sheet that is lower than the coefficient of friction of aluminum or steel relative to the filter media sheet.

In one implementation, the release coating may be in the form of a liquid or powder that is applied to the first press tooling. This may occur while the filter media sheet is passing by the first tooling.

In one implementation, the first press tooling has a base plate of a first material and a coating layer of a second material applied to the base plate. The coating layer provides the forming surface. The coating layer provides the static coefficient of friction relative to the filter media sheet and wetting angle. The second material has a lower static coefficient of friction relative to the filter media sheet than the static coefficient of friction of the first material relative to the filter media sheet.

In one implementation, the coating layer is a fluoropolymer.

In one implementation, the coating layer is in the form of a geometry plate that is attached to the base plate, the geometry plate entirely defines the first geometry. In another implementation, the base plate defines the first geometry and the coating layer takes its shape from the underlying shape defined by the base plate.

In one implementation, the process includes heating the forming surface of the first press tooling prior to manipulating the filter media sheet with the first press tooling. The heat is used to heat the filter media sheet during the pressing process.

In one implementation, the process includes heating the filter media sheet prior to pressing the filter media sheet with the first press tooling.

In one implementation, the second geometry is flat (e.g. an unpressed section of the filter media sheet).

In one implementation, the first geometry comprises a plurality of formed embossments creating pleat panel spacers that separate adjacent pleat panels when the filter media sheet is folded into pleat panels.

In one implementation, the filter media sheet is a multi-layer filter media sheet formed from a plurality of layers of filter media.

In one implementation, the filter media sheet includes an adhesive to ether secure adjacent layers together or to secure fibers of the filter media sheet together (the fibers being of the same or different layers).

In one implementation, the filter media sheet is formed from a bi-component material including a low melt component and a high melt component. The method further includes heating the filter media sheet at least to a yield point of the low melt component wherein the forming surface is configured for preventing sticking of the low melt component.

In one implementation, the filter media sheet is formed from bi-component materials including a low melt component and a high melt component. The method includes heating the filter media sheet at least to a melting point of the low melt component wherein the forming surface is configured for preventing sticking of the low melt component thereto.

In one implementation, the low melt component, upon pressing and subsequent cooling, binds the high melt component materials together. The filter media sheet is free of added adhesive and with fibers of the high melt component bound by the low melt component.

In one implementation, subsequent cooling of the pressed section of the filter media sheet sets the material of the filter media sheet such that it holds its shape.

In one implementation, each pleat panel formed between adjacent folds has a pleat height between the adjacent folds of between about 1 mm to 356 mm.

In one implementation, the pleat height between the adjacent folds is between about 127 mm to 356 mm.

In one implementation, the step of pressing the filter media sheet includes pressing the filter media sheet with a second forming surface of a second press tooling. The second forming surface of the second press tooling being a mating geometry with the geometry of the first forming surface. The first and second press tooling being in the form of press plates. The first press tooling and second press tooling moving reciprocally toward and away from one another along a pressing axis that is generally perpendicular to a travel path of the filter media sheet between the first press tooling and second press tooling.

The method may further include advancing the filter media sheet along the travel path after the filter media sheet is released by the first and second press tooling.

In one implementation, advancing the filter media sheet includes advancing the filter media sheet a sufficient distance such that a subsequent pressing process will create an unpressed section of the filter media sheet between the adjacent locations where the filter media sheet was pressed by the first and second press tooling.

In one implementation, the first press tooling is provided by a first forming roll that cooperates with a second forming roll.

In another implementation, a press tooling for creating a geometry on a filter media sheet is provided. The press tooling includes a press plate having a forming surface for forming the geometry in the filter media sheet. The forming surface has a static coefficient of friction relative to the filter media sheet between about 0.02 and 0.9 and a wetting contact angle ranging from about 90 to about 180.

In one implementation, the static coefficient of friction of the forming surface of the tooling plate is between about 0.04 to 0.2 relative to the filter media sheet.

In one implementation, the wetting contact angle is between about 90 to 140.

In one implementation, the press plate has a base plate of a first material and a coating layer of a second material applied to the base plate. The coating layer provides the forming surface. The coating layer provides the static coefficient of friction and wetting angle.

In one implementation, the coating layer is a fluoropolymer.

In one implementation a heater is provided for heating the forming surface.

In another implementation, a system for forming a geometry in a filter media sheet is provided. The system can perform the methods outlined above and use the tooling outlined above.

In one implementation, the system uses press plate tooling and includes an actuator for reciprocally pressing the press tooling into the filter media sheet. The system may include a mechanism for advancing the filter media sheet past the press tooling such that the press tooling can press the filter media sheet in different locations along a length of the filter media sheet.

In one implementation, the system includes a pleater for forming the filter media sheet into a plurality of pleat panels. Adjacent pleat panels being separated by folds. The pleater being downstream from the press plate tooling.

In one method, a method of creating a multi-layer filter media sheet having a first geometry formed therein is provided. The method includes feeding first and second material sheet to the press tooling. The first material is not secured to the second material upstream of the press tooling. At least one of the first and second material sheets is a sheet of filter media. The method includes pressing the first and second material sheets with the press tooling to simultaneously secure the first material sheet to the second material sheet to form a multi-layer filter media sheet and to form the first geometry in the resulting multi-layer filter media sheet.

In one implementation, the press tooling is provided by a pair of forming rolls. The forming rolls including geometry to form the first geometry in the multi-layer filter media sheet.

In one implementation, the first geometry extends along the entire length of the multi-layer filter media sheet.

In one implementation, heat is applied to one or more of the first and second material sheets prior to the multi-layer filter media sheet exits the press tooling.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a partially schematic side elevation view of a pressed pleat machine assembly and line that is creating pressed, pleated and embossed filter media packs;

FIG. 2 is a simplified top view of a filter media sheet after it is passed through a press tooling of the assembly line of FIG. 1 and prior to being pleated;

FIG. 3 is a photograph of formed filter media processed using prior art press tooling;

FIG. 4 is a photograph of formed filter media processed using press tooling according to an embodiment of the invention;

FIGS. 5-7 are simplified illustrations of embodiments of press plates for use in a system according to FIG. 1; and

FIGS. 8-9 are partial simplified illustrations of alternative portions of the system of FIG. 1 using press plates for forming geometries in the filter media sheet prior to pleating; and

FIGS. 10-11 are partial simplified illustrations of alternative portions of the system of FIG. 1 using forming rolls for forming geometries in the filter media sheet prior to pleating rather than press plates.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

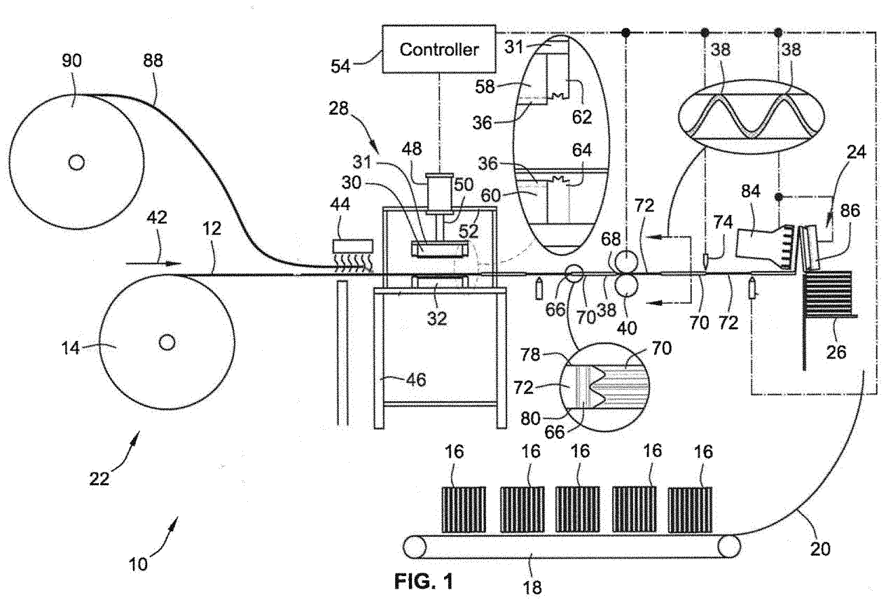

A representative system for forming filter media with geometries (e.g. embossments including pleat spacers and corrugations, etc.) formed therein and particularly pleated filter media with embossments or corrugations in the pleat panels thereof is illustrated in FIG. 1. This system and optional modifications thereof are generally described in more detail in PCT Publ. Nos. WO 2018/152090 and WO 2017/031168, the teachings and disclosures of which are incorporated herein by reference thereto.

This system is in the form of a press and pleat machine assembly line 10 that processes a continuous filter media layer in the form of filter media sheet 12 that is being unwound from a filter media roll 14. It is noted that “assembly line” in this context does not mean linear but instead means a manufacturing process in which processing steps are conducted in a series of different work stations typically in a sequence until a final product is produced. In this instance, the final products produced are a plurality of pleated filter media packs 16 that are delivered onto a conveyor 18 via a shoot 20.

The machine assembly line extends generally between an upstream region that includes a media unwind station 22 where the filter media roll 14 is placed to allow media to unwind and that is periodically replaced when the media roll 14 is exhausted thereby temporarily shutting down the line, toward a downstream region where a pleater such as media pack collector 24 is located. The media pack collector 24 includes a trap door 26 to allow a produced filter media pack 16 to ride on the pack shoot 20 to the conveyer 18.

The machine assembly line 10 includes between the upstream and downstream regions a press 28 that comprises comprising cooperating press tooling in the form of stamping dies that include an upper stamping die 30 and a lower stamping die 32. The press 28 further includes a ram 34 that drives the stamping dies 30 and 32 repeatedly into and out of engagement with each other during operation. It is noted that engagement does not require that the stamping dies 30 and 32 actually come into physical contact with one another. As can be seen in the enhanced circle image, the stamping dies comprise mating female and male geometries 36 that are adapted to form a corresponding geometry 38 into the filter media sheet as also illustrated by enlarged circle views. Geometry 38 is representative only and other geometries are contemplated.

The machine assembly line 10 further includes a media conveying mechanism such as a conveyor such as cooperating rolls 40 that serve to advance the filter media sheet 12 in a direction from the unwind station 22 region toward the region of the pleat collector 24. These cooperating rolls 40 may be located at multiple locations along the machine assembly line but in this instance is shown located between the press 28 and the pleat collector 24.

It should be noted that the cooperating rolls 40 do not deform or form the filter media in an embodiment, but instead will serve to grip the filter media and move the filter media along a path 42 leading to the media pack collector 24.

Other means of conveying the filter media sheet 12 may be employed as well.

The cooperating rolls 40 may also be chilled to effectively cool the pressed geometry of the filter media sheet 12 after the filter media sheet 12 has passed through the press 28.

In this regard, the stamping dies may also be heated and are preferably heated to an elevated temperature as described herein such that during a dwell time of the stamping dies the filter media sheet is heat-pressed to set and heat-press the desired geometry into the filter media sheet 12. For example, heater 31 may be provided to heat stamping die 30.

Additionally, or in the alternative, an optional oven or heater 44 may be arranged upstream of the press 28 to preheat the filter media sheet 12 and therefore make it more pliable for processing through the press 28.

In one implementation, the filter media sheet 12 has a low melt component and a high melt component. Heat may be applied to the filter media sheet 12, either by heater 44 or one or both stamping dies 30, 32 to raise the temperature of the low melt component to at least a yield point, a plastic deformation point, a glass transition point and/or a melting point of the low melt component. Preferably, this temperature is below the yield point, plastic deformation point, glass transition point and/or melting point of the high melt component.

However, for best geometry formation or for best adherence of multiple layers together as discussed in more detail below, the temperature is raised above the melting point of the low melt component.

In some embodiments, the low melt component and high melt component are formed from a same type of material, e.g. both polyesters, nylons, polyethylene, polypropylenes, or other polymers. Alternatively, the low melt component and high melt component could be different types of materials e.g. one could be a polymer while the other could be a cellulous material. Further yet, in some embodiments, the high melt component could be a cellulous material while the low melt material may be a hot melt.

When polymer fibers are used, the polymer fibers may be formed from, but are not limited to, polyacetals, polyamides, nylon, polypropelene, polyurethanes, epoxy, polyesters, cellulose ethers, cellulose esters, polyalkylene sulfides, polyarylene oxides, polysulfones, modified polysulfone polymers and mixtures thereof, poly(vinylchloride), polymethylmethacrylate, polystyrene, and copolymers thereof, poly(vinylidene fluoride), poly(vinylidene chloride), polyvinylalcohol in crosslinked and non-crosslinked forms.

Upon pressing the filter media sheet 12 and subsequent cooling, the low melt component binds the high melt component material (e.g. fibers thereof) together.

In some embodiments, the filter media sheet 12 is free of added adhesives. For example, the filter media sheet 12 may be a multi-layer sheet and may be free of adhesives for securing the multiple layers together. Alternatively, in some embodiments, the filter media sheet 12 may include adhesives to hold the fibers together and/or to hold multiple different layers of the filter media sheet together.

Representative adhesives used in filter media (either to hold fibers within a single layer together and/or to hold multiple layers of media in a multi-layer sheet together) include, but are not limited to, hot melts (powdered or liquid), polyamids, acrylic, latex, phenolic resins, resins, etc. For example when cellulose materials are used, an adhesive may be used to secure the cellulose materials together.

Typically, ultrasonic bonding is a way to hold synthetic media materials together. For example, a plurality of ultrasonic bonds are formed to hold the layers together and/or to hold fibers within a media together.

In an embodiment, the press 28 may include a support table 46 upon which the lower stamping die 32 is removably mounted and fixed. The lower stamping die 32 may thus be non-movable during operation. However, in other embodiments, both stamping dies 30, 32 may be actuatable. Further, the stamping dies 30, 32 are preferably replaceable for maintenance purposes and/or so that different geometries 36 can be used to form different geometries 38 into the filter media sheet 12.

Further, the ram 34 may include a hydraulic or electrical linear actuator 48 that drives shaft 50 in successive and repeated linear reciprocating movement. Shaft 50 at its end supports and carries the upper stamping die 30 which is driven linearly back and forth in close proximity to the lower stamping die 32 with the filter media sheet 12 trapped and pressed therebetween.

The linear actuator 48 may be supported via a support cage 52 that may be self-supported or supported more preferably by the table 46 to maintain the alignment between the upper and lower stamping dies 30, 32 so that the respective male and female geometries 36 in the stamping dies meet in cooperating and receiving fashion into each other.

The press 28 and its linear actuator 48 and the cooperating advance rolls 40 may be manually activated in an intermittent fashion whereby during the pressing operating the filter media sheet 12 is not advancing along the predetermined path 42 but is maintained stationary and when the press and its stamping dies 30 and 32 are released with a sufficient clearance gap therebetween, then the cooperating advance rolls 40 may be driven to advance the sheet 12 to the next location.

In other embodiments, the stamping dies 30, 32 may be carried along path 42 with the filter media sheet 12 during the stamping dwell time such that the filter media sheet 12 need not be stopped along path 42 while the stamping process occurs. Typically, a plurality of plates would be used in such an arrangement, such as illustrated in the prior arrangements.

More preferably, this is automated and done with a suitable control such as an electronic controller that may be a software programmed computer and/or a programmable logic controller. Controller 54 is shown to be connected to the cooperating rolls 40 as well as the linear actuator 48 to automate this intermittent activity such that the press is driven into engagement heat pressing the filter media sheet 12 while the cooperating advance rolls 40 are not in driving engagement. Further, the controller 54 maintains the released and separated position of the upper and lower stamping dies 30, 32 while the cooperating rolls 40 are being driven. The controller 54 alternates between these two states. Further, the controller 54 will control the cooperating rolls 40 to advance the filter media sheet 12 a predetermined distance each time and may be programmed or selected to provide regular intervals that may be equal intervals or alternatively variable distance intervals for the forming media packs of different shapes or configurations.

The press 28 and upper and lower stamping dies 30, 32 include upper and lower press plates 58, 60 and may also include both at upstream and downstream ends upper score bars 62 and lower score bars 64. The score bars and the upper and lower press plates 58, 60 may provide plate assemblies. The upper and lower score bars 62, 64 are preferably provided to also simultaneously press scores and thereby crease the filter media sheet 12 both upstream and downstream from the geometry 38 in the filter media sheet to form upstream and downstream scores 66, 68 that afford the opportunity to provide creases that serve to facilitate folding of the filter media. Folding at the creases provides the pleated filter media pack 16 with a plurality of pleat panels with the pleat panels being formed between adjacent folds.

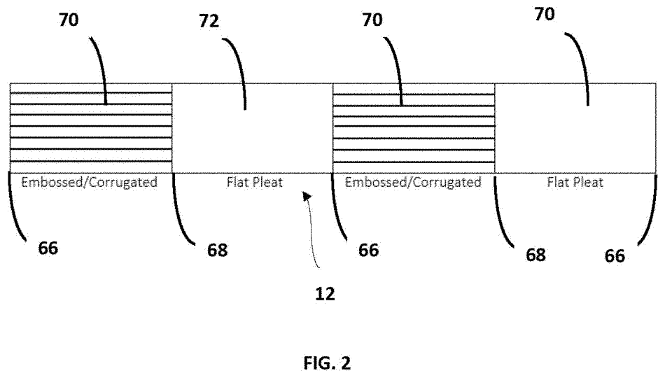

In some embodiments, the plurality of pleat panels includes a first set of pleat panels that have a first geometry formed by the press 28 and a second set of pleat panels that do not have any geometry formed therein. The illustrated system is configured to form such an alternating arrangement such that there are pleat panels 70 that have been pressed to include geometry 38 and unpressed pleat panels such as flat pleat panel 72 that are formed from portions of filter media sheet 12 that may not have been pressed and preferably has not been pressed (see a top view thereof in FIG. 2). In this configuration, each adjacent pair of pleat panels (70, 72) would have one pleat panel from the first set (e.g. a pleat panel having geometry 38 pressed therein (e.g. pleat panel 70)) and one pleat panel from the second set (e.g. a pleat panel that does not have the geometry pressed therein (e.g. pleat panel 72) or that has a different geometry pressed therein). However, the system can be configured such that every pleat panel is pressed to include the geometry 38 or that instead of providing alternating pressed and unpressed panels, the second set of panels could have a different geometry pressed therein that is different than geometry 38.

As can generally be seen, the process forms a continuous sheet of alternating embossed pleat panels 70 and flat pleat panels 72 that are joined to each other through upstream and downstream scores 66 and 68 as indicated.

When the desired length of filter media sheet 12 has been generated and passed through the machine assembly line 10, it may be manually cut or more preferably cut via an automatic pack cutting knife 74 that may be also in communication with the controller 54 to cut at appropriate times relative to the advancing cooperating rolls 40 that advance the filter media sheet 12 along the predetermined path 42. Once the controller 54 has driven the cooperating rolls 40 a predetermined distance corresponding to the desired length of filter media sheet 12 usable for the desired number of pleat panels in the pleat filter media pack 16, the pack cutting knife 74 may be actuated to cut through transversely and preferably perpendicularly to the travel path 42 to cut the sheet to length for each of the filter media packs 16. Preferably, this is also done during intermittent stoppage but may also be operated on a continuous basis in which the knife could move at an angle other than perpendicular to the path 42 to move at the same speed in the direction of the path during cutting.

Another optional feature that may be used in issues to make certain filter media pack embodiments is a trim knife 76 that may be used to trim one or both of the side edges 78, 80 of the media as schematically indicated in FIG. 1.

Additionally, another further optional and desired feature is the ability to have adhesive applicators 82 that may also be in electrical communication with the electronic controller 54 to dispense adhesive such as hot melt, urethane, glue or other such suitable adhesive upon the filter media sheet 12 at desired locations. The adhesive applicator 82 may thus dispense adhesive only while the rolls 40 are advancing the filter media sheet 12 but advantageously can also be operated during the intermittent stopping to apply adhesive while the filter media sheet is stopped such as applying across the filter media sheet if additional stitch beads are desired. The adhesive 82 may also be applied at different locations and there may be more than one adhesive applicator 82 such as on opposed side edges 78, 80 that may apply adhesive on opposed side edges 78, 80 of the filter media sheet 12 in order to seam the side edges and form pocket pleats. For example, the adhesive applied by the adhesive applicator 82 upon the edges of filter media sheet 12 may seam together and form a sealed seam on opposed side edges to in effect form a pocket pleat.

Downstream of the press and optional bonding, various forms of pleaters may be used including pleat collectors that simply fold the filter media pack.

One form of pleat collector as illustrated is in the form of an ultrasonic plunge welder 84 that works in conjunction with an ultrasonic anvil 86 that are configured with ultrasonic horn features that mate and contact with each other to ultrasonically bond and weld adjacent portions of the filter media sheet together. The plunge welder 84 and the anvil 86 may be driven towards and away from each other with adjacent pleat panels 70, 72 therebetween. The plunge welder 84 and anvil may also be used to form bonds at seams and/or form point bonds through ultrasonic welding and/or thereby form the features such as pocket pleats as discussed in PCT Publ. Nos. WO 2018/152090 and WO 2017/031168. Each of the plunge welder 84 and the anvil 86 are movable toward and away from each other and may be moved away from each other to allow the plunge welder 84 to allow advancement of pleat panels of the filter media sheet and to weld features upon the immediate pleat panels of the sheet of the in-process filter media pack 16 that is positioned in media pack collector 24.

The movement of the plunge welder and the anvil may also be coordinated relative to the action of the cooperating rolls 40 and may be active during intermittent stoppage and can also be operated during advancement of the filter media sheet along the path 42. The plunge welder 84 may include suction and a vacuum on its face in order to pick up and temporarily secure the pleat panel to itself and facilitates folding of the filter media sheet along the upstream and downstream scores 66, 68 that are created by the corresponding score features of the upper and lower score bars 62, 64.

Yet another optional feature that may be employed is the ability to combine multiple sheets together. For example, sheet 88 may be combined with sheet 12 to form a multi-layer sheet. Sheet 88 may be an additional filter media sheet, a scrim, a support, a screen such as expanded metal for support or other such laminate feature which may be desired to be employed. In some embodiments it may be desired to have two layers of filter media sheet to provide for a first level of filtration to capture larger particles and thereby a less efficient upstream surface to the filter media sheet and a more efficient downstream layer to the filter media. Accordingly, a second sheet 88 may be dispensed from second roll 90 to overlay either above or below filter media sheet 12 and also run through the similar components including the press 28 of the machine assembly line 10. Accordingly, with this configuration the second sheet 88 would also be pressed with the same geometry 38 as in the filter media sheet 12.

While the system of FIG. 1 illustrates multiple sheets (e.g. sheets 12 and 88) being combined as the sheets 12, 88 are being run through the press 28, other embodiments, may only have a single sheet provided. That single sheet may be a multi-layer sheet that was formed from a plurality of layers laminated together in an off-line lamination process prior to pressing.

The fibers of the various layers of filter media may be made from cellulose, plastic polymer, formable glass, etc. The layers can be manufactured by being wet-laid, spun-bound, melt-blown, electro-spun, force spun or a combination of the aforementioned processes.

Typically, laminated multi-layer sheets require the use of a hotmelt adhesive between the adjacent layers or a component fiber in one or both layers of media to secure the layers together.

While FIG. 2, as discussed above, illustrates an embodiment where the filter media sheet 12 has alternating pressed and unpressed pleat panels 70, 72, all of the pleat panels could be pressed with the same geometry or the unpressed pleat panels 72 could be pressed with a different geometry than the geometry of pressed pleat panel 70.

Typical tooling have a forming surface that defines the desired geometry formed from steel or aluminum. The applicants have determined that, unfortunately, when using press tooling such as that, the filter media sheet can stick to the forming surface of the press plates that directly contacts the filter media sheet. When the filter media sheet sticks to the tooling, the shape of the geometry may not adequately form when the filter media sets or the filter media itself may be damaged such as by way of delaminating multi-layer filter media.

Embodiments of the present invention provide improvements to reduce this problem.

The applicants have determined that the static coefficient of friction between the press tooling and the filter media as well as the wetting contact angle of the forming surface of the tooling can affect this sticking problem. Typically, aluminum has a static coefficient of friction of between 1.05 and 1.35 relative to the filter media sheet and a wetting contact angle of 40 to 70.

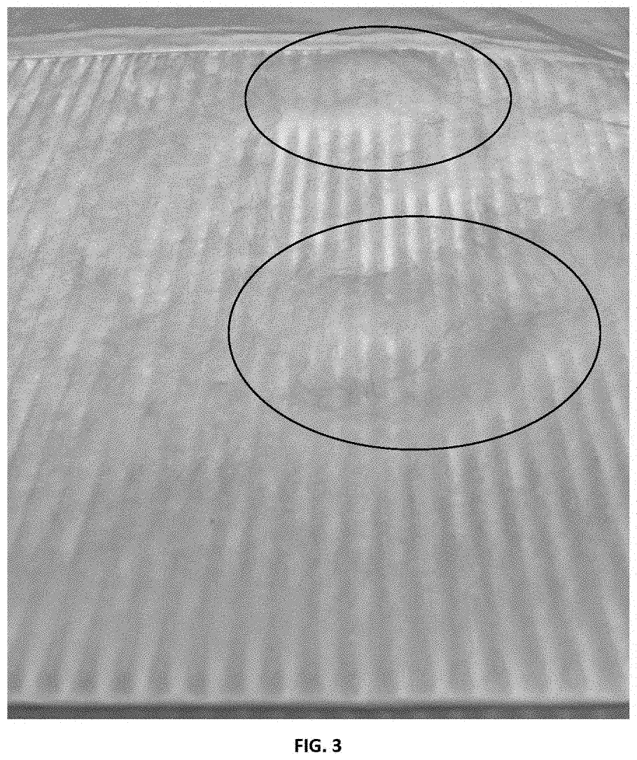

FIG. 3 is an image of a multi-layer composite media that was damaged due to the filter media sticking to the press tooling. In FIG. 3, particular areas of damage have been circled.

The applicants have determined that if the static coefficient of friction between the tooling and the filter media sheet is between about 0.02 and 0.9 and more preferably between about 0.02 and 0.4, the sticking problem is reduced. In some contemplated embodiments, the static coefficient of friction may be within a range having a low end of anyone of 0.02, 0.03, 0.04, 0.05, 0.06, 0.07, 0.08, 0.09, or 0.1 and a high end of anyone of 0.2, 0.3, 0.4, 0.5, 0.6, 0.7, 0.8, or 0.9. Again, it is preferred that the static coefficient of friction is as low as possible.

Further, the applicants have determined that the wetting contact angle of the forming surface of tooling that contacts the filter media sheet 12 can affect the sticking problem. The applicants have determined that a wetting contact angle of between about 90 and 180 degrees and more preferably between 90 and 140 degrees will prevent sticking of pressed media to the press tooling. The wetting contact angle can be determined by use of a goniometer using de-ionized water.

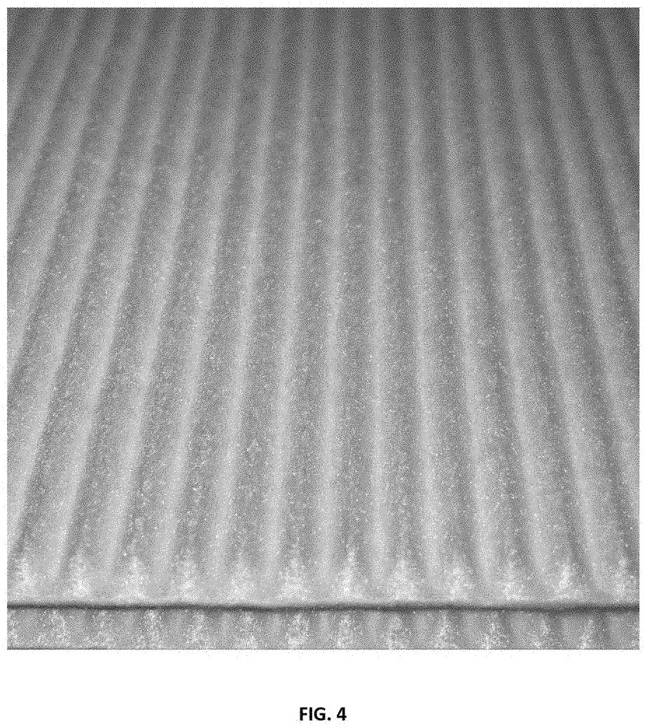

FIG. 4 is an image of a pressed filter media sheet that was formed by pressing that was not damaged by the press tooling as it exited the tooling because the tooling had a forming surface finish that conforms to the parameters outlined above. A comparison of FIG. 3 and FIG. 4 clearly illustrates the improved quality of the geometry formed into the filter media by way of use of the present invention. It is noted that the filter media in FIG. 3 and FIG. 4 are the same except for the pressing process used to form the geometry.

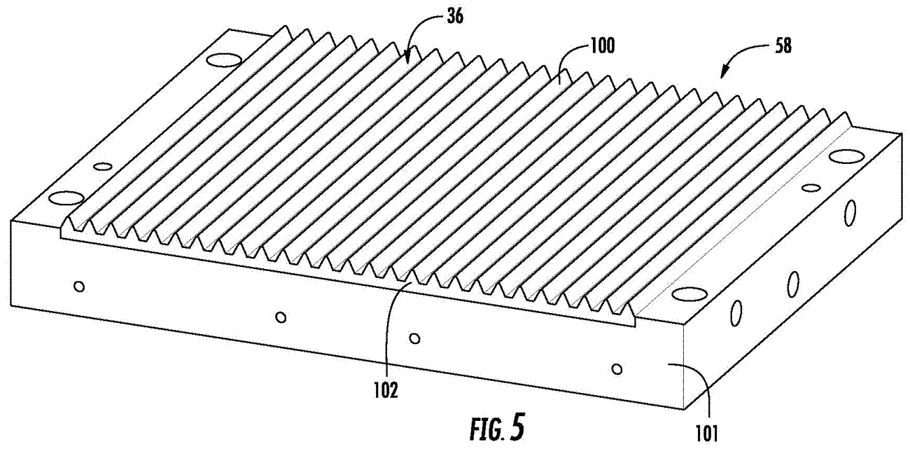

FIG. 5 illustrates press tooling in the form of press plate 58 according to an embodiment. In this embodiment, the press plate 58 has a forming surface 100 that defines male/female geometry 36. This forming surface 100 has a coefficient of friction relative to the filter media sheet being pressed and wetting contact angle as outlined above.

In this embodiment, the press plate 58 includes a base plate 101 of a first material, such as aluminum or steel, and a geometry plate 102 of a material having the desired static coefficient of friction and wetting contact angle characteristics to avoid undesirable sticking. The geometry plate 102 directly defines the male/female mating geometry 36 and contacts the filter media sheet 12 when the geometry 38 is being pressed into the filter media sheet 12. The geometry plate may be attached to the base plate 101 by way of adhesives, bolts, or mechanical fitment. Other bonding of the base plate 101 to the geometry plate 102 are also contemplated such as chemical bonding.

The static coefficient of friction of the second material that forms the geometry plate 102 is less than the static coefficient of friction of the first material and/or the wetting contact angle of the second material is greater than the wetting contact angle of the first material.

In an alternative implementation illustrated in FIG. 6, the press tooling is in the form of a press plate 258. The press plate 258 has a forming surface 200 that defines the male/female geometry 236. This forming surface 200 has a coefficient of friction relative to the filter media sheet being pressed and wetting contact angle as outlined above.

In this embodiment, the press plate 258 includes a base plate 201 of a first material, such as aluminum or steel, and a coating 202 of a material having the desired static coefficient of friction and wetting contact angle characteristics to avoid undesirable sticking. The base plate 201 generally defines the male/female mating geometry 236. The coating 202 covers at least the portion of the base plate 201 that defines the male/female geometry. It is this coating 201 that contacts the filter media sheet 12 when the geometry 38 is being pressed into the filter media sheet 12. In some embodiments, the coating 202 is chemically bonded to the base plate 201. It is contemplated that other means for securing the coating 202 to the base plate 201 may be used such as adhesives or other mechanical connections.

It is contemplated that the material used for geometry plate 102 or coating 202 could be polytetrafluorethylene (ptfe) or other similar fluoropolymers, ceramic coatings, anodized coatings, chrome plating, other polymers, etc.

In an alternative implementation illustrated, it is contemplated that a press plate 358 can have a metal base plate 301 that defines the forming surface 300 that directly contacts the filter media sheet 12 during the pressing process. The metal may be, for example, steel or aluminum but the portion of forming surface 300 that defines the male/female geometry 336 is highly polished to provide the desired static coefficient of friction and wetting contact angle characteristics.

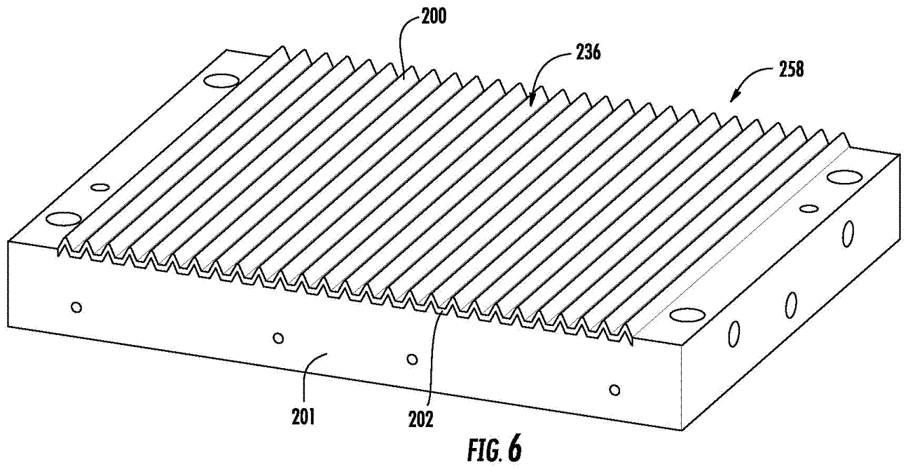

In a further implementation, a release agent could be applied directly on the forming surface of the press plate that defines male/female geometry 36 to provide the desired static coefficient of friction and wetting contact angle characteristics. FIG. 7 is illustrated to include such a release agent. The release agent is illustrated in the form of dots applied to the forming surface 300.

A highly polished surface and a release agent can be used in combination and need not be used in the alternative, e.g. such as illustrated in FIG. 7.

The release agent could be in powder or liquid form. An example of a contemplated release agents include a silicone based release agent or ptfe or similar material based lubricant.

The release agent could be applied to the forming surface of the press plate from time to time during the manufacturing process at predetermined intervals. Alternatively, the release agent could be applied when it is determined that the filter media sheet 12 is sticking to the press tooling causing detrimental effects to the quality of the pressed portion of the filter media sheet 12. For example, after a predetermined length of media has passed through the press 28 the release agent could be reapplied to the tooling. Alternatively, if damage to the filter media due to undesirable sticking is determined either manually or by automatic testing, the release agent could be reapplied to the tooling.

Preferably, any release agent that is used is inert relative to the type of filter media being pressed so as to avoid effecting the filtration properties of the filter media.

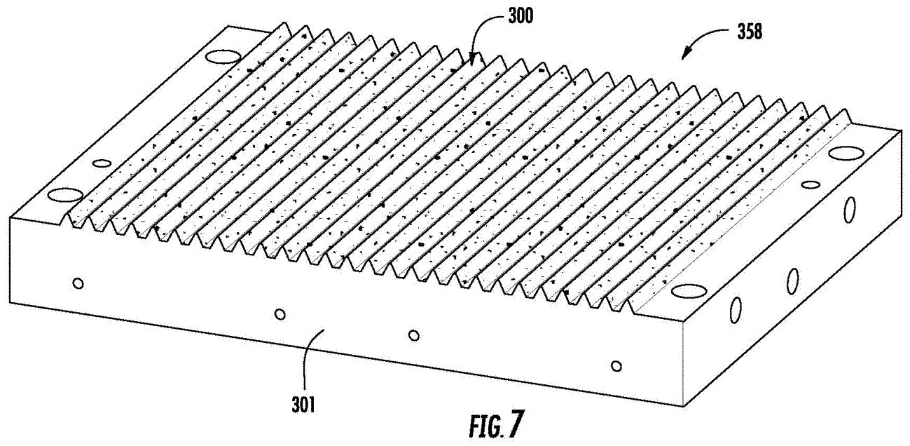

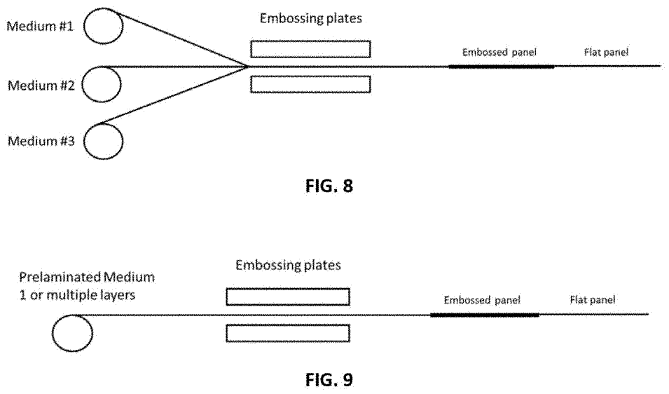

FIG. 8 is a schematic illustration of an alternative arrangement similar to FIG. 1. This embodiment uses three different sources of filter media to form a multi-layer filter media sheet. In this embodiment, the multiple layers forming the multi-layer filter media sheet are being combined and bonded during the pressing process discussed previously.

FIG. 9 is a schematic illustration of an alternative arrangement where a single sheet is being processed. The single sheet could be a single layer of media or a plurality of layers of media that were previously combined prior to being supplied to the system. This is unlike the prior embodiment where combining multiple layers and pressing are performed using a single system.

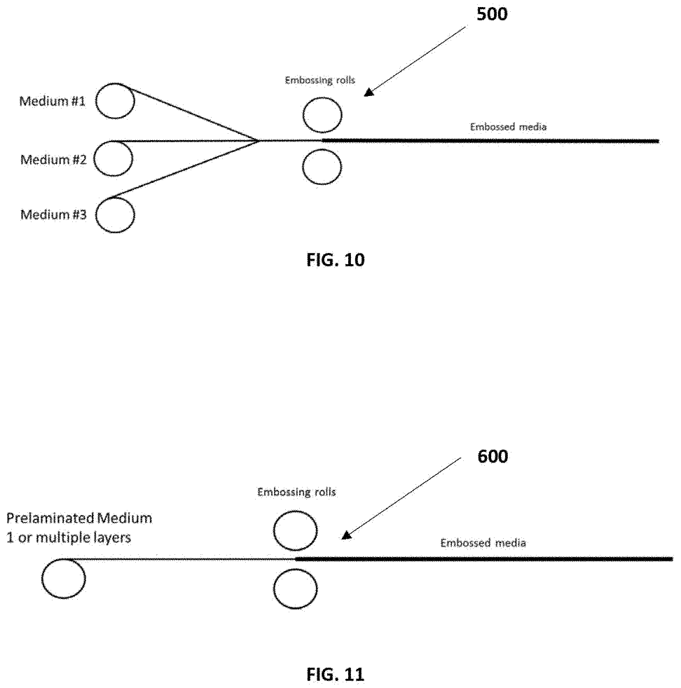

FIGS. 10 and 11 are similar to FIGS. 8 and 9, respectively. However, these systems do not use stamping dies and the associated press plates to form geometries into the filter media sheet. Instead, these embodiments use press tools in the form of in-line forming rolls. These forming rolls 500, 600 form the desired geometry (e.g. embossments, corrugations, etc.) as the filter media sheet passes between the opposed forming rolls 500, 600.

While not illustrated, these embodiments would also use heat and/pressure to form and maintain the desired geometry.

The forming rolls 500, 600 are configured to have the same static coefficient of friction and wetting angle properties identified above. Similar to the press plates described above, these characteristics can be obtained by providing an outer tube of material having those characteristics that fully defines the male/female geometries on the opposed forming rolls.

Alternatively, the male/female geometries could be formed into a base roll and the geometries are coated with a second material that provides the desired static coefficient of friction and wetting angle.

While the embodiments of FIGS. 8-11 indicate that embossing plates and embossing rolls are used, other press tooling can be used to form other geometries in the filter media sheets than embossments. While cylindrical rolls are illustrated, in other embodiments, the press tooling could be opposed forming belts that form the geometry into the filter media sheet.

Further yet, a release agent could be applied to the forming rolls 500, 600 to provide the desired static coefficient of friction and wetting angle.

In other embodiments, the base rolls could be highly polished to provide the desired static coefficient of friction and wetting angle.

While FIGS. 10 and 11 illustrate that all of the media exiting the forming rolls 500, 600 has the geometry formed therein, in other embodiments, one or both of the pair of forming rolls 500, 600 could be mounted to a linear actuator to drive the forming rolls 500, 600 toward and away from one another in a reciprocating manner to form intermittent sections of pressed and unpressed filter media similar to that of FIG. 2.

By providing press tooling (press plates or forming rolls) with the desired forming surface characteristics of static coefficient of friction and/or wetting angle, the issues related to sticking of the filter media and/or adhesives to the press tooling is eliminated or reduced such that materials that materials that were previously thought to not be able to be processed can now be processed with significantly improved quality and consistency. Again, this finds particular benefit for multi-layer filter media, filter media with bi-component materials (particularly bi-component materials with different melting temperatures) and/or filter media that includes adhesive for adhering adjacent layers to one another or for adhering fibers of an individual layer to one another.

It is a feature of systems such as those illustrated in FIGS. 8 and 10 that the press tooling can perform multiple functions simultaneously. More particularly, the press tooling can be used to secure multiple layers of material together while simultaneously forming the desired geometry into the resulting filter media sheet.

As illustrated in FIGS. 8 and 10, separate layers of material are fed to the press tooling where the press tooling is used to secure the multiple layers together to form a single multi-layer filter media sheet that includes geometry formed therein.

The press tooling, e.g. press plates or forming rolls, is preferably operated in these situations, e.g. where multiple layers of material are secured together, such that substantially the entire length of the filter media is pressed together and secured together.

When using the forming rolls, the forming rolls can be used to form continuous corrugations along the entire length of the resulting multi-layer filter media sheet.

As discussed previously, heat can be applied upstream of the pressing process or during the pressing process to help form the geometry as well as to help secure the multiple layers of material.

For example. Heat can be applied to raise the temperature of one or more components to at least a yield point, a plastic deformation point, a glass transition point and/or a melting point of the one or more components to facilitate securing the adjacent layers of material to one another as they exit the press tooling.

As noted above, low and high melt components can be provided in one or multiple of the layers to facilitate this securement.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A process for creating a first geometry on a filter media sheet, comprising the steps of:
a. providing a press tooling including a forming surface for forming the first geometry, the forming surface of the press tooling having a static coefficient of friction relative to the filter media sheet of between about 0.02 and 0.9 and a wetting contact angle ranging from about 90 to about 180;
b. pressing the filter media sheet with the forming surface of the first press tooling to form the first geometry in the filter media sheet; and
c. removing the formed filter media sheet from the first press tooling.

2. The process of claim 1, wherein the static coefficient of friction of the forming surface of the first press tooling relative to the filter media sheet is between about 0.04 to 0.2.

3. The process of claim 2, wherein the wetting contact angle is between about 90 to 140.

4. (canceled)

5. The process of claim 1, further comprising folding the filter media sheet to form a plurality of pleat panels from the filter media sheet.

6. The process of claim 5, wherein pleat panels of a first set of the plurality of pleat panels include the first geometry formed by the first press tooling and pleat panels of a second set of the plurality of pleat panels have a second geometry different than the first geometry, each adjacent pair of pleat panels includes a pleat panel of the first set of the plurality of pleat panels and a pleat panel of the second set of the plurality of pleat panels, the pleat panel of the first set of the plurality of pleat panels of the adjacent pair being separated from the pleat panel of the second set of the plurality of pleat panels by a fold.

7. The process of claim 1, further comprising the step of applying a release coating to the forming surface of the first press tooling, the release coating providing a coefficient of friction relative to the filter media sheet that is lower than the coefficient of friction of aluminum or steel relative to the filter media sheet.

8. The process of claim 1, wherein the first press tooling has a base plate of a first material and a coating layer of a second material applied to the base plate, the coating layer providing the forming surface, the coating layer providing the static coefficient of friction relative to the filter media sheet and wetting angle, the second material having a lower static coefficient of friction relative to the filter media sheet than the static coefficient of friction of the first material relative to the filter media sheet.

9. The process of claim 8, wherein the coating layer is a fluoropolymer.

10. The process of claim 1, further comprising heating the forming surface of the first press tooling prior to pressing the filter media sheet with the first press tooling.

11. The process of claim 1, further comprising heating the filter media sheet prior to manipulating the filter media sheet with the first press tooling.

12. The process of claim 5, wherein the second geometry is flat.

13. The process of claim 1, wherein the first geometry comprises a plurality of formed embossments creating pleat panel spacers when the filter media sheet is folded into pleat panels.

14. The process of claim 1, wherein the filter media sheet is a multi-layer filter media sheet formed from a plurality of layers of material; wherein the step of pressing the filter media sheet also secures the plurality of layers of material together while the first geometry is being formed.

15. The process of claim 1, wherein the filter media sheet includes an adhesive.

16. (canceled)

17. The process of claim 1, wherein the filter media sheet is formed from bi-component materials including a low melt component and a high melt component;
the method further comprising heating the filter media sheet at least to a melting point of the low melt component wherein the forming surface is configured for preventing sticking of the low melt component thereto.

18. The process of claim 17, wherein the low melt component, upon pressing and subsequent cooling, binds the low and high melt components together;
wherein the filter media sheet is free of added adhesive and with fibers of the high melt component bound by the low melt component.

19. The process of claim 6, wherein each pleat panel formed between adjacent folds has a pleat height between the adjacent folds of between about 1 mm to 356 mm.

20. (canceled)

21. The process of claim 1, wherein the step of pressing the filter media sheet includes:
pressing the filter media sheet with a second forming surface of a second press tooling, the second forming surface of the second press tooling being a mating geometry as the geometry of the first forming surface,
the first and second press tooling being in the form of press plates, the first press tooling and second press tooling moving reciprocally toward and away from one another along a pressing axis that is generally perpendicular to a travel path of the filter media sheet between the first press tooling and second press tooling;
further comprising advancing the filter media sheet along the travel path after the filter media sheet is released by the first and second press tooling.

22. The process of claim 21, wherein advancing the filter media sheet includes advancing the filter media sheet a sufficient distance such that a subsequent pressing process will create an unpressed section of the filter media sheet between the adjacent locations where the filter media sheet was pressed by the first and second press tooling.

23. The process of claim 1, wherein the first press tooling is provided by a first forming roll that cooperates with a second forming roll.

24. A press tooling for creating a geometry on a filter media sheet, the press tooling comprising:
a press plate having a forming surface for forming the geometry in the filter media sheet, the forming surface having a static coefficient of friction relative to the filter media sheet between about 0.02 and 0.9 and a wetting contact angle ranging from about 90 to about 180.

25. The press tooling of claim 24, wherein the static coefficient of friction of the forming surface of the tooling plate is between about 0.2 to 0.04.

26-27. (canceled)

28. The press tooling of claim 24, wherein the press plate has a base plate of a first material and a coating layer of a second material applied to the base plate, the coating layer providing the forming surface, the coating layer providing the static coefficient of friction and wetting angle.

29. The press tooling of claim 28, wherein the coating layer is a fluoropolymer.

30. The press tooling of claim 24, further comprising a heater for heating the forming surface.

31-32. (canceled)

33. A method of creating a multi-layer filter media sheet having a first geometry formed therein, the method comprising:
a. providing a press tooling including a forming surface for forming the first geometry;
b. feeding a first material sheet to the press tooling
c. feeding a second material sheet to the press tooling, the first material not being secured to the second material upstream of the press tooling, at least one of the first and second material sheets being a sheet of filter media;
d. pressing the first and second material sheets with the press tooling to simultaneously secure the first material sheet to the second material sheet to form a multi-layer filter media sheet and to form the first geometry in the resulting multi-layer filter media sheet.

34. The method of claim 33, wherein the press tooling is provided by a pair of forming rolls, the forming rolls including geometry to form the first geometry in the multi-layer filter media sheet.

35. The method of claim 33, wherein the first geometry extends along the entire length of the multi-layer filter media sheet.

36. The method of claim 33, further comprising applying heat to one or more of the first and second material sheets prior to the multi-layer filter media sheet exits the press tooling.

37. The method of claim 36, wherein the step of applying heat raises the temperature of one of the first and second material sheet above a melting point of one of the first and second material sheet.
